(19) United States
(12) Patent Application Publication
(10) Pub. No.: US 2007/0113290 A1
(43) Pub. Date: May 17, 2007

(54) Method of detecting and preventing illicit use of certain network protocols without degrading legitimate use thereof

(76) Inventors: Olivier Charles, Clamart (FR); Laurent Butti, Issy Les Moulineaux (FR); Franck Veysset, Issy Les Moulineaux (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/581,120

(22) PCT Filed: Nov. 8, 2004
(86) PCT No.: PCT/FR04/02872

§ 371 Date: May 30, 2006

(51) Int. Cl. H04L 9/32

(52) U.S. Cl. 726/27

(57) ABSTRACT

A method of preventing illegitimate use of a network protocol consisting of a stream of data packets, wherein the method comprises steps of calculating a delay that is an increasing function of the bit rate of a stream coming from a machine, and forwarding packets of the stream after said delay.

The present invention relates to a method of detecting and preventing illicit use of certain network protocols without degrading legitimate use thereof.

It finds one particular application in IP network security, where it provides an effective barrier to various types of attack that are characterized by a sudden rise in the bit rate of the corrupted protocol, in particular denial of service attacks and hidden channel attacks. It is particularly efficacious on paid access public wireless networks (known as “hot spot” networks).

The invention has two aspects, in particular in the sense that the bit rate of the protocol concerned constitutes a criterion for detecting an attack as well as means for eradicating an attack. The second aspect of the invention is based on the use of a delay function whereby any packet received by the system is forwarded with a delay that is negligible when there is no attack in progress and rises if an attack is detected, to the point of rendering the network unusable by the attacker.

The method of the invention is independent of the technology on which the IP network is based: Ethernet IEEE 802.11, GPRS, etc.

The method of the invention provides an effective solution to a form of fraud known as firewall piercing or a hidden channel attack.

These fraud techniques enable streams that are normally prohibited to pass through a device for filtering information, by encapsulating the prohibited streams in streams that are authorized. The invention solves this problem in difficult situations in which until now there has been no solution.

The method of the invention has the advantage of preventing fraud without having any significant negative impact on legitimate use of the network.

More generally, any attack or fraud based on an unusual exchange of data with the local area network is easily dealt with by the present invention provided that it causes a significant rise in relation to the bit rate that is normally used by the protocol that has been compromised.

Thus certain denial of service attacks (which make a service unusable by other users through pure malice) can also be dealt with, especially in hot-spot networks, the hot spot being a radio coverage area in which an appropriately equipped terminal can log onto and obtain access to the Internet, subject to a prepayment or a charge levied by a provider of access to a communications network such as the customer's GSM network. This situation arises when the hot spot is connected to a mobile network operator in order to use GSM authentication.

In this situation, another possible form of attack from the hot spot and against the machine that manages user authentication is critical because that machine is the GSM network authentication server. Mobile network operators fear this kind of denial of service attack as it can imperil the GSM network authentication server and, through a boundary effect, the GSM network itself.

The present invention enables an abnormally large number of requests to be detected automatically and restricted.

Techniques known as “firewall piercing” are often used on business networks to transport prohibited protocols. The invention is preferentially applied to signaling protocols such as DNS, ICMP, or EAP (which transports an authentication method), i.e. protocols that are merely used by other protocols on the Internet and do not transport user data directly. These signaling protocols are very different from data transport protocols in that they operate at bit rates that are normally low and known. If ever they are used as transport protocols during an attack, this should lead to an abnormally high number of requests and responses.

However, the invention also applies to transport protocols. In particular, it applies to providing total or partial protection of low bit rate transport protocols.

More particularly, the invention processes signaling protocols such as DNS. For example, at a public hot spot it is frequently the case that, by default, all streams are prohibited except signaling protocols, which are essential for starting up user connections (transporting authentication data, collecting information on the configuration of the network, resolution of names). Thus a fraudster seeking to use a hot spot without paying could make use of the signaling protocols on their own in order to construct a hidden channel. Conversely, “useful” protocols such as HTTP or Telnet cannot be fraudulently used as hidden channels because they are blocked by a firewall until the user is authorized to log on.

Another aspect of the invention processes protocols like HTTP and FTP. Ordinarily, HTTP has a highly asymmetrical bit rate: a low bit rate from the terminal to the server, which corresponds to requests, and a high bit rate in the opposite direction, which corresponds to HTML pages served up in response to requests. If a hidden channel attack on HTTP were to violate this characteristic bit rate of an HTTP connection, i.e. if the uplink bit rate were suddenly to become abnormally high, then the invention would be in a position to block that traffic.

In order to achieve these objects, the present invention provides a method of detecting and preventing illegitimate use of network protocols without hindering legitimate use thereof, in which, for an incoming stream of data packets, the method consists in applying a delay function to each packet, thereby applying a delay that is not sufficient to hinder legitimate use, but that is sufficient to hinder illegitimate use.

Particularly, in a signaling protocol, the invention applies a delay function that increases with the bit rate of the monitored stream, such that if the illegitimate use of the protocol for transporting private data exceeds a standard rate, the delay increases indefinitely, thereby practically blocking the channel that is being used illegitimately, without hindering other streams.

Other features and advantages of the present invention become clearer in the light of the following description and the appended drawings, in which:

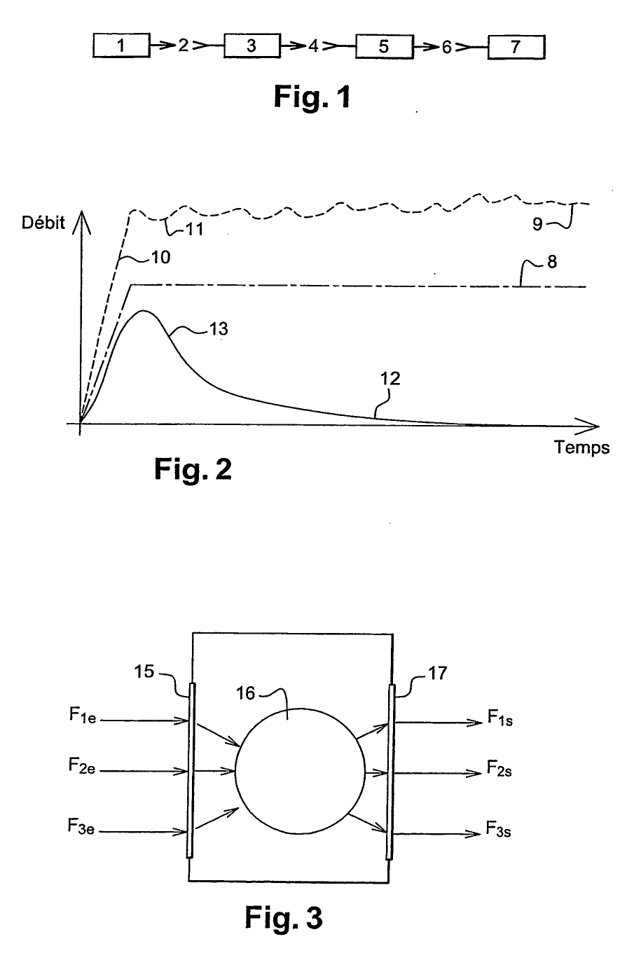

FIG. 1 represents a sequence in accordance with a protocol to be protected;

FIG. 2 is a time diagram of the bit rates of streams under surveillance conforming to another protocol to be protected, in the situation of an attack that is not blocked and in the situation an attack that is blocked by the method of the invention;

FIG. 3 is a block diagram of equipment for processing streams under surveillance by the method of the invention;

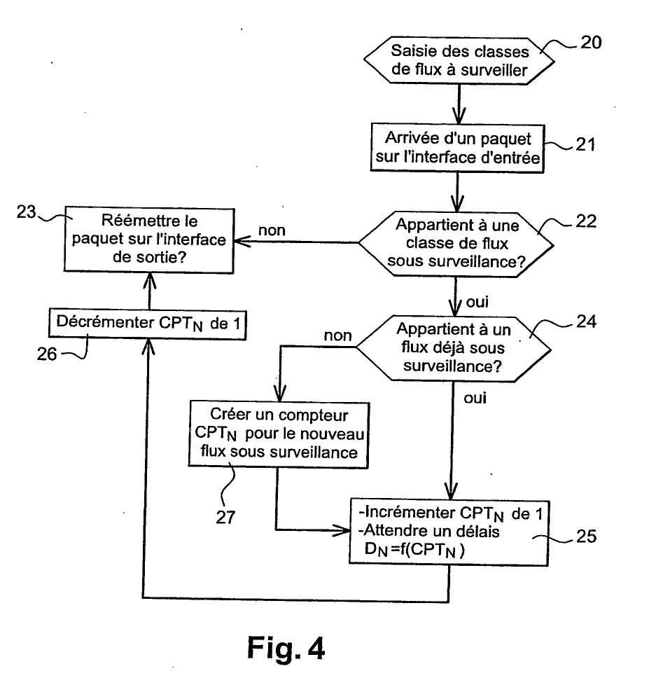

FIG. 4 is a flowchart of one particular embodiment of the method of the invention;

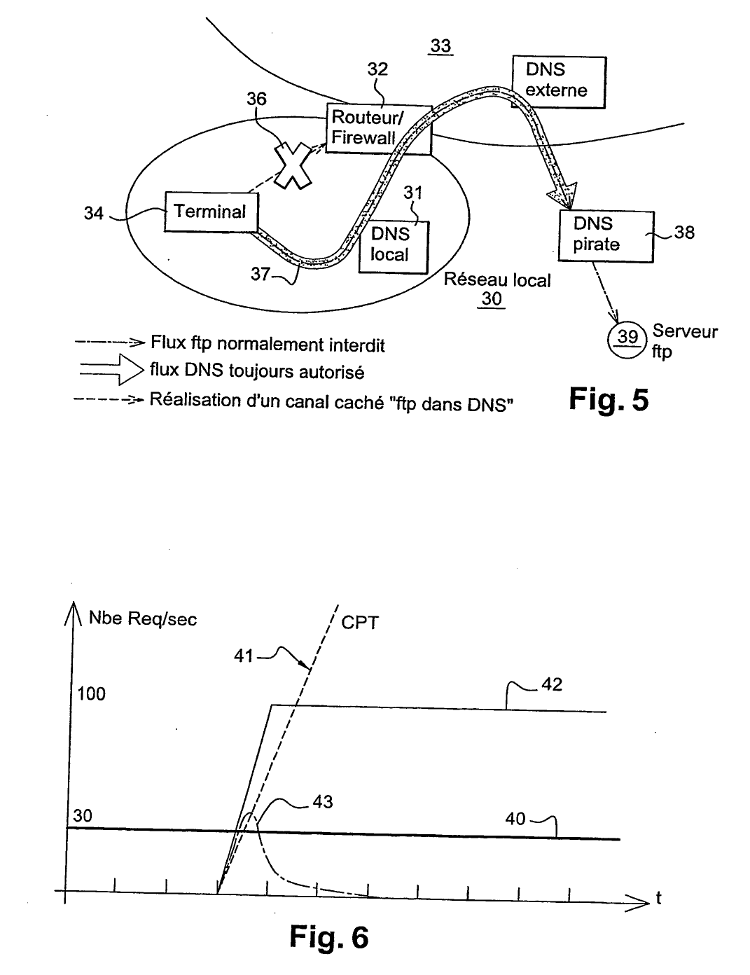

FIG. 5 is a diagram explaining various scenarios in a first example of an application of the invention; and

FIG. 6 is a time diagram explaining a scenario in a second example of an application of the invention.

Two attack techniques are described below. The first attack technique can be used on IP networks, which may be business networks, the Internet, or hot spot networks. The second attack technique is specific to hot spot networks and is aimed in particular at a GSM authentication server connected to a hot spot network.

As a general rule, the terminals connected to an IP network operated by a business, a telecommunications carrier, or an Internet access provider are not free to make any type of connection regardless. There are three major reasons for this.

A first reason is that the network is a production network and there is a requirement for users not to be able to use it illegitimately for entertainment, personal advantage, or causing nuisance to others.

A second reason is that use of the network has to be paid for and it is necessary to authorize only streams for which users have paid.

A third reason is that authorizing more connections than are necessary for correct operation of the network proprietor organization can only be indicative of illegitimate use.

Streams entering and leaving the network are generally filtered in equipment at the boundary of the network such as filter routers or firewalls (referred to collectively below as “firewalls”). Moreover, for the authorized protocols to work correctly, these equipments must allow other essential protocols such as ICMP (RFC 792) or DNS (RFC 1034) to pass without restriction.

Software tools exist that enable those protocols that are authorized by a firewall to be used to pass protocols that are prohibited. Those techniques are known as “hidden channel attacks” or “firewall piercing” and are all based on the same scheme, which is described with the aid of FIG. 5, which shows this type of attack in the situation where DNS is used to transport data through the firewall:

a) The pirate leaves a free-access server somewhere on the Internet, outside the network to which the terminal is connected. That server has two functions:

i. Encapsulating/disencapsulating packets coming from the pirate's machine; and

ii. Forwarding the extracted packets to the final destination and receiving packets from that destination to forward them to the pirate (this is the relay function).

b) The pirate's terminal copies a data packet of a prohibited protocol into a free area of a packet of an authorized protocol and sends it to the free-access server, which processes it.

In this way, the pirate succeeds in injecting and extracting traffic that is normally prohibited by encapsulating it in a packet of an authorized protocol. This kind of fraud is to be feared for two reasons:
practically all protocols allow encapsulation; and
firewalls must necessarily allow certain protocols to pass through them that are known to have this encapsulation capability, such as DNS and ICMP; merely blocking those protocols would mean that the network would not conform to recommendations on good working and interoperability and would prevent normal use by legitimate users.

Hot spot networks that use SIM card authentication methods are based on a communications protocol called EAP-SIM that is defined in published standards and allows GSM authentication between a hot spot service client and a GSM mobile telephone operator. GSM authentication requires few resources (low system load). A large number of authentication requests can degrade quality of service both for users of standard GSM services and for users of Wi-Fi network services.

FIG. 1 is a diagram of authentication by the EAP-SIM method. An enquirer 1 on the communications network sends an authentication request 2 conforming to an 802.11 protocol to an authentication resource 3.

The authentication resource executes an authentication operation and supplies an authentication response 4 conforming to a protocol AAA to an authentication server 5 that in response produces an authentication message 6 that is transmitted in accordance with the SS7 protocol to an authentication centre 7.

Applying the EAP-SIM scheme in the case of an attack, the modus operandi is as follows:

The attacker signals to the access point that he is ready to be authenticated (EAPOL_Start);

The access point then requests the attacker to identify himself (EAP-Request/Identity);

The attacker therefore responds with an identity: the network access identifier NAI (REC 2486) contained in EAP-Response/Identity;

The access point relays the response of the attacker to Proxy-RADIUS;

Proxy-RADIUS analyses the content of the NAI and forwards the response to the operator's RADIUS server using the content of the NAI (after the @ symbol);

The operator's RADIUS server analyses the request containing the NAI (in particular the IMSI code);

The operator's RADIUS server then requests the attacker to authenticate himself with the GSM authentication (EAP-Request/SIM/Start) via the Proxy-RADIUS of the visited hot spot;

The attacker responds with an EAP-Response/SIM/Start (Nonce);

Proxy-RADIUS then forwards that response to the operator's RADIUS server;

The operator's RADIUS server then interrogates the GSM authentication base to recover n GSM triplets (n=2 or 3).

It is the last of the above phases that is costly, as it enables the attacker to have n GSM triplets calculated.

The attack therefore consists in maximum replaying of the preceding modus operandi by sending a type of packet initiating the authentication phase (EAPOL_Start packets). It is then possible to effect a denial of service attack by saturating resources of the authentication centre 7, which imperils the hot spot network and more importantly the GSM network.

There are three prior art methods of solving problems linked to communications protocol attacks:
methods using firewalls;
methods using bit rate monitoring systems; and
methods using intrusion detection and prevention systems.

Firewalls are usually employed to monitor the streams on a network and are generally placed at a break between two sub-networks to analyze the packets that pass through them. They are able to apply filtering at various levels:
IP/ICMP: the system analyses the content of the fields of the headers (source/destination IP address, type and ICMP code);
IP/TCP UDP: the system analyses the content of the fields of the headers (source/destination IP address, TCP UDP port);
Session: the system effects a complete analysis of a session initialization for setting up a call using a particular protocol and therefore ensures that the incoming packets actually correspond to outgoing packets;
Content of the data exchanged in the application protocols to prohibit certain contents (e.g. pornography site URL).

However, firewalls are not able to block streams resulting from hidden channel attacks because they use “all or nothing” filtering: if the stream is declared valid, they pass everything, whereas if the stream is declared invalid, no packets are passed. Hidden channel attacks are more subtle as they use authorized streams (or even essential streams such as DNS streams). Consequently, the only element enabling this kind of attack to be identified is the abnormally high bit rate that these legitimate protocols generate when they are being used for a hidden channel attack. No firewall provides this kind of filtering criterion.

What is more, the method of the invention offers “self-adaptive” filtering of suspect traffic which:
quickly blocks suspect streams;
automatically lifts the blocking once the situation has returned to normal;
offers a response appropriate to each type of attack in terms of speed of blocking, bit rate limit, speed of lifting blocking, as described below for the function f( ); and
avoids totally blocking a legitimate stream, even if it is too large, by only slowing it down, as described below for the “subnormal” operating mode.

The traffic therefore continues to pass, even if service is slightly degraded. A conventional firewall would block it completely.

Bit rate monitoring systems assign a portion of the total available bandwidth to one type of stream, in particular to avoid congestion situations. They form part of quality of service management systems. To some degree, they prevent the fraudulent use of network bandwidth. For example, they limit the total bit rate of DNS requests and thereby reduce the scope for DNS hidden channel attacks. Software such as the open source ipfilter software, through its “limit” module, offers this kind of bit rate limitation function.

However, this does not completely silence an attacker since the attacker can still send data at the maximum bit rate authorized by the system.

FIG. 2 shows the response in terms of bit rate to a DNS hidden channel attack.

FIG. 2 shows on the same timing diagram:
the bit rate 12 characteristic of a protocol protected by the method of the invention when an attack occurs;
the bit rate 8 characteristic of a protocol protected by a bit rate monitoring system during the same attack; and
the bit rate 9 characteristic of a protocol with no protection during the same attack.

In the event of an attack, the bit rate increases relatively quickly along a slope 10, after which the traffic remains substantially constant with random oscillations about a steady state bit rate value.

By applying bit rate monitoring by means of a prior art bit rate monitoring system, the bit rate of the attack rises more slowly than in the above situation and then remains constant, locked at a threshold value that corresponds at least to the bit rate 8 of a signaling protocol that is most demanding of bit rate.

When the method of the invention is applied, the bit rate of the attacker passes through a maximum 13 and then decreases more or less quickly to the point at which it is eliminated, as explained below.

It is clear in FIG. 2 that the bit rate monitoring system can do no better than limit the bandwidth available for the attack. In contrast, the method of the invention makes the bit rate tend towards zero with a convergence rate that is set by a parameter. From this point of view, the invention is much more effective than stream monitoring systems in preventing hidden channel attacks.

Intrusion detection systems (IDS) work by analyzing streams circulating on the main paths by means of a probe that feeds collected data back to an “intelligent” system that interprets the data and issues an alarm if something suspect occurs. The system can also instruct a firewall to cut off the traffic if necessary.

These systems are referred as active intrusion detection systems. Another development of these systems consists of intrusion prevention systems (IPS).

In this case, the IDS is coupled directly to a firewall, the analyzed stream passing through that equipment. This offers traffic cut-off possibilities similar to active intrusion detection systems, but with shorter reaction times. The detection principles remain the same and the pertinent data on which analysis is based generally consists of sequences of known sent messages called attack signatures.

IDS are known to have serious drawbacks:
they are very costly because of the technology of the probe, which must be capable of analyzing large quantities of traffic;
they are not very reliable in that, like any automatic recognition system, they issue unjustified alarms (false positives) and conversely they allow attacks to pass through (false negatives);
they aim to detect only known attacks.

Their response to an attack is not satisfactory. In the case of an IDS, an alarm is sent to the human operator, who must react accordingly. The permanent presence of an operator is unthinkable in the case of a small network. The response in the case of an IPS is no better than that of a firewall (see below).

The method of the invention may be implemented either in a dedicated equipment or as an additional function of existing stream-processing equipment, for example a router, a firewall, or a DNS server. In all cases, it is essential for all of the traffic that is to be monitored to pass through the equipment. Stream-processing equipment of this kind, as shown diagrammatically in FIG. 3, includes an input interface 15 and an output interface 17, and traffic arriving at the input interface is forwarded to the output interface in compliance with logic defined by the method of the invention.

The invention is based on the following principle, which is executed on a processor 16 of the stream-processing processing equipment: the stream Fie is forwarded to the output interface as a stream Fjs with a greater or lesser delay, the delay being neither too long, so as to remain acceptable to “honest” users, nor too short, enabling a dishonest user to pass unauthorized data.

From the physical point of view, the two interfaces may be implemented on the same network card.

The distinction between input and output is valid for traffic in one direction. If the invention also processes traffic in the opposite direction, the roles of the interfaces are interchanged.

In the method of the invention, the classes of streams under surveillance are designated first.

The designation of the classes of streams under surveillance may be based on the values of certain fields of the IP packet, as when configuring IPsec gateways (RFC 2401) or firewalls.

For example, a designation of the classes of streams by a combination of the following values may be adopted: a source IP address or a range of source IP addresses, a destination IP address or a range of destination IP addresses, a higher level protocol (UDP, TCP, ICMP, etc.), a port number, a value of a field in the higher level protocol portion.

Generally speaking, any protocol field that can be read and interpreted by the equipment may be retained as a selection criterion, regardless of its level in the protocol stack.

Specifically, in the situation where the invention works only as an add-on to a particular service, it is not always necessary to implement a complete stream class designation system. For example, if the method of the invention is added to a DNS name resolution server with the aim of preventing hidden channel attacks on the DNS protocol, then only the DNS stream class is put under surveillance (see below). Consequently, there is no utility in providing the facility to designate other stream classes.

In one embodiment of the invention, the mechanism for clamping the streams under surveillance is readied.

When a stream Fie is detected at the input interface 15 of the stream processing equipment coming from a particular machine and belonging to a stream class that is under surveillance, a count associated with that stream is created dynamically. For the stream N, the associated count is denoted CPT_{N}.

In one embodiment of the invention, the stream processor 16 uses an unauthorized stream clamping mechanism.

Each time that a data packet arrives at the input interface 15 during a step 21:

During a step 22, a surveillance test is executed; if the packet does not belong to a stream that is under surveillance, it is forwarded immediately to the output interface 17 during a step 23.

During a step 24, it is verified whether the packet that has arrived belongs to a stream that is under surveillance.

If it belongs to a stream that is under surveillance, i.e. if a count CPT_{N} is already associated with it, then, during a step 25, the count CPT_{N} is incremented by one step, such as by unity 1, and during a step 23, the packet is forwarded after a delay D_{N}=f(CPT_{N}) to the output interface 17, which delay depends on a predetermined function f( ) of the current value of the count CPT_{N}.

The function f( ) is called the delay function.

In one embodiment, for each packet forwarded to the output interface 17, the count CPT_{N} is decremented by one step, such as unity 1, during a step 26.

One embodiment of the method of the invention includes a mechanism for removing a stream from surveillance.

The count CPT_{N} reaching a sufficiently low value indicates that there is no longer any attempt to send illegitimate traffic. The count CPT_{N} can then be eliminated, and the traffic is then no longer under surveillance. This is not essential, however, and the traffic may remain under surveillance indefinitely.

If, after test 24, the packet is not identified as belonging to a stream class that is under surveillance, then its stream is assigned a new count CPT_{N} and step 25 is executed.

The delay function f is not necessarily the same for all stream classes. Thus a DNS stream could be delayed with a function f1 and an ICMP stream with a function f2.

The delay function f must be at least an increasing function so that the more traffic the attacker sends, the more the attacker's traffic is delayed.

A delay function f with a positive second derivative will very quickly block the stream from the attacker, for example f(CPT_{N})=exp(α*CPT_{N}+β) with α>0.

A count CPTMAX_{N} may also be used in the event of an attempt to saturate the monitoring equipment; if the number of packets awaiting transmission exceeds a parameter value CPTMAX_{N} set by the administrator, then the waiting packets are destroyed in accordance with an algorithm to be selected. The aim of this function is to prevent saturation of the resources of the invention.

An embodiment of the method of the invention implemented in a DNS server local to the network to be protected is described here.

An attack proceeding without intervention of the method of the invention is described below.

A local area network 30 with stream monitoring is often constructed on the basis of the scheme shown in the FIG. 5 diagram. The local area network contains terminals, for example a terminal 34, a DNS server 31 called the local DNS, and a router/firewall 32 which connects the local area network 30 and another network 33 such as the Internet.

The router/firewall 32 is configured to prohibit certain streams, for example FTP streams. To circumvent the prohibition 36, the terminal 34 encapsulates IP packets that transport the FTP stream in DNS packets on DNS stream paths 37, for example, coding information in specific fields of the packet. By carefully choosing the domain names of the request, it also ensures that the DNS request can be processed only by the pirate DNS server 38 under the control of the pirate external to the local area network. The pirate DNS machine 38 can then transfer the packets to the FTP server 39 requested by the terminal. Traffic in the opposite direction takes exactly the opposite path.

By implementing the invention on the local DNS server, hidden channel DNS attacks are completely blocked.

1) In the precise situation shown in FIG. 5, there is no need to implement management of stream classes and streams under surveillance. In fact, only DNS streams pass through this machine.

2) Moreover, all DNS streams may be put under surveillance by associating a stream to be put under surveillance with a count, i.e. creating a count CPT for each terminal and never eliminating it. A maximum value CPTMAX of CPT is fixed, such as CPTMAX=2000.

3) It is decided arbitrarily that before a service, such as an HTTP service, for example, is authorized on the local area network, a threshold bit rate expressed by a maximum number of DNS requests is acceptable, for example 30 per second per terminal.

4) It is assumed that a hidden channel attack by a terminal causes a sudden rise in the number of DNS requests of the order of 100 per second.

5) f(CPT)=exp(CPT/15) is selected as the delay function (expressed in milliseconds).

Three operating modes of a DNS system can be distinguished:
normal operation: the user is not malicious and uses the system in the manner intended;
abnormal operation: the user is malicious and is probably in the process of committing an attack on the system; and
subnormal operation: the user is not malicious but is momentarily operating the system slightly beyond the intended limits.

The following analysis shows that the system adapts automatically to the above three situations to enable the user to use the DNS service correctly in the “normal” and “subnormal” situations, although there is then a small loss of quality of service, and to block traffic in the “abnormal” situation. The following analysis is not rigorous but illustrates with numerical values one implementation of the method, which may be followed on the FIG. 6 timing diagram showing the changing numbers of requests per second as a function of time.

FIG. 6 shows the changing numbers of DNS requests per second as a function of time. Because of the structure of the DNS server, the count assigned to the stream under surveillance increases along a straight line 41. The curve 42 indicates the arrival of requests during the attack and the curve 40 indicates the acceptable number of requests in the DNS server. Finally, the curve 43 indicates the changing number of requests forwarded to the output interface of the DNS stream processing equipment in which the protection method of the invention is applied.

1) “Normal” Situation

If the system is not under attack, it receives DNS requests to be processed at a frequency of the order of 30 per second (level 40, FIG. 6). The delay applied to each packet is then exp(30/15)=7.39 ms. This value shows that a packet will be delayed by at most 7.39 ms. This means that practically all of the packets arriving during a period of one second will be forwarded during the same second. In fact, 30 packets blocked at the maximum of 7.39 ms represents a total duration of 221.7 ms, which is much less than one second. Consequently, the count CPT retains a value close to 0.

2) “Abnormal” Situation

If the system is experiencing an attack on a DNS server, the method of the invention assigns a count CPT to the stream of the attacker and that count changes as plotted by curve 41. For example, 100 requests per second are sent, on average. The packets are slowed down by exp(100/15)=785.77 ms. Consequently, over the period, the count CPT will have risen by an amount δCPT, broadly from 50 to 100, since very few of the packets that arrive will be forwarded. The delay applied thereafter to the packets that arrive one second later will be
exp((100+δCPT)/15)=exp(δCPT)*785.77 ms>>20 s.

It is therefore clear that the applied delay rapidly becomes totally blocking (20 s) and continues to increase up to the limit fixed by the maximum value of CPT.

3) “Subnormal” Situation

The system may suffer a sudden and momentary increase in the number of requests even if it is not under attack. This occurs when a user is viewing an HTML page which contains many URLs, for example 40 URLs. CPT will then leave the “correct operation” zone momentarily. A maximum delay of exp(40/15)=14.39 ms will be applied, which is imperceptible to the user displaying an HTML page in a browser. Moreover, this value does not allow CPT to increase immoderately because the 40 packets that have arrived, even delayed by 14.39 ms, can leave during the second in which they arrive. An “all or nothing” system would have blocked the traffic completely because it departed from the correct operation zone (CPT<30). Conversely, the invention introduces only a slight loss of quality of service (a delay of 14.39 ms), which is removed as the system reverts to the “normal” mode of operation.

By way of a second example, there follows a description of how the method of the invention may be implemented in a Proxy-RADIUS server local to the network to be protected.

Overall, the process is similar to that described above for implementation in the DNS service. In fact, the basic idea in the case of limiting the impact of attacks on GSM authentication is to use the invention to break into GSM authentication transport. Consequently, the description below is more succinct and concentrates exclusively on topics specific to GSM authentication.

The simplest position for the monitoring mechanism is in the Proxy-RADIUS, for more than one reason:

Authentication transits the proxy-RADIUS, regardless of the target GSM operator (roaming);

Modifications to the operator's GSM network are very costly and can have a strong impact on GSM customers.

The fields used for the monitoring mechanism will be contained in the data of the EAP-SIM authentication mechanism. In fact, it is possible to tell from which operator the EAP-SIM authentication is requested (in the form of users@operatorGSM). It is therefore possible to implement the invention at the level of the hot spot to protect all GSM operators from this type of denial of service attack.

The monitoring mechanism is then executed in the normal situation of the invention (see FIG. 3), which limits the number of authentication requests by analyzing the behavior of authentication transport.

Note that the present invention also includes detection of illegitimate use. In fact, in one embodiment of the invention the protocol also includes a step of detecting a change to the bit rate associated with a stream under surveillance characteristic of illegitimate use. This applies in particular if the count associated with a stream under surveillance passes through a maximum value and then falls rapidly towards zero bit rate. Under such circumstances, the method of the invention produces an alarm in respect of such illegitimate use. An alarm signal of this kind is sent to a network administrator, who can take any appropriate action, in particular by maintaining a record of incidents, seeking the identity of the authors of such illegitimate use, and applying any subsequent measure to reduce access by such authors.

### ABBREVIATIONS

DNS: Domain Name Service
EAP: Extensible Authentication Protocol
EAP-SIM: EAP-Subscriber Identity Module
GSM: Global System for Mobile communications
ICMP: Internet Control Message Protocol
IP: Internet Protocol
NAI: Network Access Identifier
RADIUS: Remote Access Dial in User Service
TCP: Transport Control Protocol
UDP: User Datagram Protocol
IDS: Intrusion Detection System
IPS: Intrusion Prevention System
RFC: Request For Communication
HTTP: HyperText Transfer Protocol
FTP: File Transfer Protocol
HTML: HyperText Mark-up Language

1-10. (canceled)

11. A method of preventing illegitimate use of a network protocol consisting of a stream of data packets, wherein the method comprises the steps of:
calculating a delay that is an increasing function of the bit rate of a stream coming from a machine; and
forwarding packets of said stream after said delay.

12. The method according to claim 11, wherein the delay function depends on the value of a count (CPT_{N}) of data packets of said stream.

13. The method according to claim 12, wherein the delay function has a positive second derivative.

14. The method according to claim 12, further comprising:
a step of determining a maximum permissible value (CPTMAX_{N}) of the bit rate for the stream; and
a step of destroying waiting data packets if the number of data packets that has arrived exceeds the maximum permissible value (CPTMAX_{N}).

15. The method according to claim 11, further comprising a step of stopping the calculation of the delay for said stream if the count (CTP_{N}) of packets is below a predefined value.

16. The method according to claim 11, wherein the stream under surveillance is of the signaling protocol type.

17. The method according to claim 11, further comprising:
a step of detecting a change of the bit rate associated with said stream toward a maximum value and a maximum reduction of said bit rate toward a zero bit rate; and
a step of producing and sending an alarm.

18. The method according to claim 16, wherein the method adapts automatically and:
in a normal operation step during which the protocol is used as intended, the packet count retains a value less than a predetermined value and greater than or equal to 0;
in an abnormal operation step during which the system is subject to an attack, the count increases; and
in a subnormal operation step during which the system is used momentarily beyond its limits, the count retains a value less than a predefined value.

19. A device for processing a stream of data packets coming from a machine, wherein the device comprises delay means for delaying forwarding of the stream coming from said machine by a delay that is an increasing function of the bit rate of said stream.

20. A telecommunications system adapted to process data traffic comprising at least one stream of data packets coming from a machine, wherein the system comprises delay means for delaying forwarding of at least one stream coming from said machine by a delay that is an increasing function of said bit rate.

21. A computer program including instructions for executing the steps of the method according to claim 11 when said program is executed on a computer.

22. A processor adapted to execute the computer program according to claim 21.
